(19) United States
(12) Patent Application Publication
(10) Pub. No.: US 2025/0001356 A1
(43) Pub. Date: Jan. 2, 2025

(54) ADDITIVES FOR IMPROVED ELECTROCHEMICAL CO2 CAPTURE

(71) Applicant: THE REGENTS OF THE UNIVERSITY OF CALIFORNIA, Oakland, CA (US)

(72) Inventors: Jeffrey Barlow, Irvine, CA (US); Jenny Y. Yang, Irvine, CA (US)

(21) Appl. No.: 18/703,504

(22) PCT Filed: Dec. 1, 2022
(86) PCT No.: PCT/US2022/080754

§ 371 Date: Apr. 22, 2024

Related U.S. Application Data
(60) Provisional application No. 63/284,904, filed on Dec. 1, 2021.

(51) Int. Cl. B01D 53/32

(52) U.S. Cl. CPC B01D 53/326; B01D 2257/504

(57) ABSTRACT

Redox capture agents and stabilizing agents for electrochemical capture and concentration are described herein. The addition of stabilizing agents such as hydrogen-bond donors shifts the reduction potentials of capture agents such as quinones such that they may be used to reversibly bind carbon dioxide even in the presence of oxygen. Furthermore, the stabilizing agents may advantageously tune the binding properties of the capture agents for various specific applications. Common hydrogen-bond donors such as ethanol may provide redox carrier-based systems with significantly improved efficiency and stability.

### CROSS-REFERENCES TO RELATED APPLICATIONS

This application claims benefit of U.S. Provisional Application No. 63/284,904 filed Dec. 1, 2021, the specification of which is incorporated herein in its entirety by reference.

### FIELD OF THE INVENTION

The present invention relates to capture agents and stabilizing agents for use in electrochemical carbon compound (e.g., carbon dioxide, carbon monoxide, etc.) capture and concentration.

### BACKGROUND OF THE INVENTION

Electrochemical carbon dioxide capture and concentration (eCCC) is a growing area of research within the field of carbon dioxide capture, and provides unique advantages over thermal-swing based carbon dioxide capture and concentration (CCC) methods. The most appealing of these advantages is the independence from Carnot limitations, allowing theoretical efficiencies up to 100%. Among the multiple approaches to eCCC, the utilization of redox-active carrier species is among the most popular. Several classes of redox-active carriers have been investigated for eCCC applications including: bipyridines, thiols, and quinones. While quinones have shown to be potent eCCC carriers in the absence of O₂, with examples of systems capable of concentrating <1% CO₂ streams into >90% in more than one example, all reported systems are incapable of operating under aerobic conditions. Due to the large concentration of molecular oxygen present in flue gas, other industrial gases, and atmospheric CO₂ resources, the quinone must be capable of capture at potentials positive of the O₂/O₂^{⋅-} couple to avoid unproductive carrier oxidation and the generation of superoxide, which can undergo destructive radical reactions with the carrier, solvent, or electrolyte.

In addition to redox potential, the CO₂ binding constant (K_{CO2}) must also be properly tuned for the desired application. In order to attain >90% capture efficiency from flue gas, log(K_{CO2}) must be greater than ˜3.2 using polar aprotic solvents. A plot of log(K_{CO2}) versus E_{1/2} for a variety of quinones in polar aprotic solvents can be seen in FIG. 2, which also includes lines indicating the O₂/O₂^{⋅-} couple (dotted black line), as well as the minimum value of log(K_{CO2}) needed for flue gas or atmospheric capture (dotted green and blue lines, respectively). The shaded green and blue regions indicate the working regimes required for eCCC from flue gas or atmospheric resources respectively. As observed in the figure, the carrier properties display a linear free energy relationship (LFER) between the binding constant (log(K_{CO2})) and required reduction potential (E_{1/2}), which lies outside of the required working regimes for both flue gas and atmospheric capture applications. Due to the lack of carriers that operate within the necessary regimes, the observed LFER must be broken to allow eCCC from flue gas or atmospheric resources.

The nature of CO₂ binding to reduced quinone species permits a unique approach to stabilize both the active-state and CO₂-bound carrier species at milder potentials without sacrificing binding affinity. FIG. 6 shows a generic reaction coordinate diagram for quinone reduction and binding to one molecule of carbon dioxide based on the EEC mechanism for TCQ proposed by both Dubois and Ogura, and confirmed by our studies. A unique feature of quinone CO₂ reactivity is that both the reduced quinone (species A), and its CO₂ adduct (species B) are anionic. Quinones have been reported to exhibit significant cationic shifts in reduction potential (ΔE_{1/2}) in the presence of Lewis-acidic species such as hydrogen-bond donors or group I/II metal cations through stabilization of the quinone dianion (ΔE_{1/2} for species A, FIG. 6). While the effects of Lewis acids on K_{CO2} have not been reported, it may be that the CO₂ adduct would be similarly stabilized (blue species B), due to the anionic charge maintained before and after binding CO₂. If species A and B are stabilized to the same degree, there should be little to no effect on K_{CO2}, as it is directly dictated by the energy difference between the two species, but the reduction potential should be anodically shifted. As a result, proper tuning of Lewis acid-quinone interactions may promote potent eCCC redox carriers that operate at milder potentials, effectively breaking the observed LFER to allow operation under aerobic conditions.

### BRIEF SUMMARY OF THE INVENTION

It is an objective of the present invention to provide systems, devices, compositions and methods that allow for electrochemical carbon dioxide capture and concentration in the presence of oxygen, as specified in the independent claims. Embodiments of the invention are given in the dependent claims. Embodiments of the present invention can be freely combined with each other if they are not mutually exclusive.

Hydrogen-bonding interactions between quinone molecules and various alcohols were investigated. The presence and strength of the hydrogen bonding interactions with the reduced quinones and CO₂-bound quinones result in stabilization of the reduced quinone species, allowing their generation at reduction potentials over 350 mV positive compared to when alcohol was not present. Although generated at much milder reduction potentials, the mechanism and reversibility of CO₂ binding to quinones was unaffected. The reduced quinone and CO₂-bound quinones are remarkably stable; voltametric and spectroscopic studies of the two species in alcoholic solutions do not show evidence of protonation or decomposition, even after several hours.

Quantitative measurement of the strength of hydrogen-bonding interactions between the quinones with each alcohol establish the first example of selective electrochemical CO₂ capture from aerobic flue gas. Electrochemical capture and concentration from simulated anaerobic flue gas (10% CO₂, 3% O₂, and 87% N₂) using 2M ethanol in DMF resulted in successful completion of a full cycle of CO₂ capture and release approaching 26% efficiency. Not only would this be the first example of eCCC from aerobic flue gas, it is also extremely efficient, over three times more efficient than any other reported redox carrier-based system, and almost twice the efficiency of state-of-the-art alkanolamine-based system. Surprisingly, in the absence of alcohols, the quinone was incapable of completing a full cycle, even under anaerobic conditions.

In some embodiments, the present invention uses hydrogen-bonding interactions with reduced TCQ and tunes these interactions to stabilize TCQ in both CO₂-bound and -unbound forms.

One of the unique and inventive technical features of the present invention is the use of a stabilizing agent to shift the reduction potential of a capture agent positive of the reduction potential of oxygen. Without wishing to limit the invention to any theory or mechanism, it is believed that the technical feature of the present invention advantageously provides for the use of the reduced capture agent to bind CO₂ in the presence of oxygen without undesired side-reactions. For example, without wishing to limit the invention to any theory or mechanism, it is believed that the technical feature of the present invention advantageously allows the reduction potential of the redox couple comprising the capture agent in its oxidized state and the capture agent in its reduced state to be shifted anodically of the reduction potential of the redox couple comprising oxygen and superoxide. For example, without wishing to limit the invention to any theory or mechanism, it is believed that the technical feature of the present invention advantageously provides for the use of the reduced capture agent to bind CO₂ in the presence of oxygen without undesired side-reactions that may be generated by the presence of superoxide or other reduced forms of oxygen. Without wishing to limit the invention to any theory or mechanism, it is believed that, for example, the use of the reduced capture agent to bind CO₂ in the presence of oxygen without the generation of superoxide may prevent undesired reactions with, for example, the capture agent. For example, it may prevent oxidation of the capture agent which might impair the ability of the capture agent to capture carbon dioxide or another molecule to be captured or otherwise degrade the capture agent. None of the presently known prior references or work has the unique inventive technical feature of the present invention.

The system described is over three times more efficient than any other reported redox carrier-based system, and almost twice the efficiency of state-of-the-art alkanolamine-based system.

A unique advantage of incorporating hydrogen-bonding additives into quinone-based eCCC systems is the ability to judiciously tune both E_{1/2} and K_{CO2} to match the desired parameters of the eCCC application. The ability to tune these parameters not only allows optimization of energetic efficiency, but also permits a single quinone carrier to be efficiently utilized in a wide range of eCCC applications, making it a very cost-effective approach towards large-scale eCCC solutions with different gas mixtures.

Another unique advantage of the present invention is the use of stabilizing agents to achieve optimized interactions between capture agents and carbon dioxide or another compound to be captured by the capture agent via the modification of the capture agent's redox potential without interfering with binding between the capture agent and carbon dioxide or other compound to be captured. Without wishing to limit the invention to any theory or mechanism, it is believed that, for example, by selecting a stabilizing agent with an ideal pKₐ for a given capture agent, an ideal stabilizing agent may be selected for a given capture agent, thus achieving optimized interactions between the capture agent and carbon dioxide or another molecule to be captured without interfering with binding of the same.

Furthermore, the inventive technical feature of the present invention contributed to a surprising result. For example, it is surprising that the addition of hydrogen-bond donor stabilizing agents both shifted the reduction potential of quinone capture agents and also improved the binding characteristics of the capture agents. For example, one of ordinary skill in the art might expect that a stabilizing agent would inhibit rather than improve the binding characteristics of a capture agent, since the stabilizing agent might, for example, serve as a competitive inhibitor to the binding of carbon dioxide or another compound to the capture agent. It is also surprising that the hydrogen-bond donor improved the overall cyclability and stability of the capture system.

Although this system is capable of operating at a very high efficiency, it is possible to increase the efficiency even further. Since the energetic requirement of a carrier to complete a capture and release cycle is directly related to its binding affinity, it is important that K_{CO2} is properly tuned for the desired concentration swing. If K_{CO2} is too low, CO₂ will not be captured by the carrier; if it is too high, superfluous energy is required to release bound CO₂. Although Dubois and Hatton have shown quinones to be robust eCCC carriers, each system operates with extremely low efficiency (≤8%) for the concentration swings performed. The inefficiency of these systems is a direct result of utilizing quinones with extremely large binding affinities (K_{CO2}≥10¹⁰), overshooting the minimum requirement by several orders of magnitude. Overcompensation of carrier binding affinity is also observed with TCQ²⁻, albeit to a much lesser extent. A log(K_{CO2})≥3 is required for ≥90% capture efficiency from flue gas (10% CO₂). The log(K_{CO2}) of TCQ²⁻ in DMF containing 2M ethanol exceeds the requirement of K_{CO2} by over an order of magnitude (log(K_{CO2})=4.3±0.2), wasting over 7 kJ for every mole of CO₂ captured (resulting in an efficiency of 26% using a 3-stage system). If the incoming CO₂ concentration is lowered to 1%, a log(K_{CO2})≥4 is required for ≥90% capture efficiency, which better matches the log(K_{CO2}) of TCQ²⁻, and would result in an efficiency exceeding 40% (A 1-100% swing requires 11.4 KJ/mol and ΔE for a 3-stage system using a TCQ²⁻ carrier containing 2M ethanol is ≤290 mV).

The experimental setup utilized for eCCC electrolyses may be further improved. First, the maximum CO₂ concentration measured upon release was just a little over 35%, not the 100% desired for large-scale flue gas capture systems. This value can be raised by either increasing the carrier concentration or lowering the headspace to solution volume ratio in the working cell. Cell leakage is also a potential problem with the current setup, as CO₂ concentrations dropped more than expected during the capture step in one instance with extended periods of electrolysis. Leakage prevents accurate determination of Faradaic efficiency and stability of TCQ²⁻ over numerous eCCC cycles.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWINGS

The features and advantages of the present invention will become apparent from a consideration of the following detailed description presented in connection with the accompanying drawings in which:

FIG. 1 shows a general process for eCCC systems featuring a redox carrier in its resting state (R) that binds to CO₂ upon reduction (to Rⁿ⁻) to form R(CO₂)ⁿ⁻ with a CO₂ binding constant of K_{1,CO2}. Upon oxidation of R(CO₂)ⁿ⁻ to form R(CO₂), CO₂ is released to regenerate the resting-state carrier, R. If O₂ is present, deactivation of the active carrier can occur through electron transfer.

FIG. 2 shows a relationship between reduction potential and CO₂ binding constant. Plot of Log(K_{1,CO2}) versus E_{1/2} for reported quinone dianion species in: DMF (black squares), DMSO (blue triangles), or CH₃CN (red circles), and TCQ in 2M EtOH in DMF as reported here (star). Selected structures are shown next to their corresponding data points. The vertical black dotted lines indicate the range of O₂/O₂^{⋅-} couples in the reported solvents. Dotted horizontal lines represent the minimum requirement of Log(K_{1,CO2}) from flue gas (green) or atmospheric (blue) resources. Shaded regions display the working regimes necessary for flue gas (green) or atmospheric (blue) eCCC applications.

FIGS. 3A-3B show the effect of alcohol additives on reduction potential and electronic absorption spectra of TCQ. FIG. 3A shows normalized cyclic voltammograms of TCQ containing 100 mM concentrations of various alcohol additives; decreasing alcohol pKₐ results in larger anodic shifts to the second redox event. All voltammograms were recorded using DMF solutions containing 0.2 M TBAPF₆ electrolyte and 2.0 mM TCQ analyte concentrations under N₂ atmosphere. FIG. 3B shows normalized electronic absorption spectra of TCQ²⁻ obtained during UV-vis SEC experiments. Experiments were performed in DMF containing no alcohol (black trace), 1M ethylene glycol (orange trace), 2M ethanol (blue trace), or 2M tert-butanol (red trace) with 0.2 M TBAPF₆ electrolyte and 0.7 mM TCQ under N₂ atmosphere. For each solution, no protonation (to form the corresponding hydroquinone TCQH₂, (black dashed trace) is observed.

FIG. 4 shows TCQ^{⋅-} Properties in DMF and in 2M EtOH in DMF. Proposed reduction and CO₂ binding mechanism of TCQ with CO₂ in the presence and absence of intermolecular hydrogen-bonding interactions from ethanol. Experimentally determined thermodynamic values are shown for each step.

FIGS. 5A-5B show the effect of alcohol additives on the reduction potential and electronic absorption spectra of TCQ under 1 atm of CO2. FIG. 5A shows normalized cyclic voltammograms of TCQ under N2, CO2, and containing 100 mM concentrations of various alcohol additives under CO2; decreasing alcohol pKa results in larger anodic shifts to the second redox event. All voltammograms were recorded in DMF solutions containing 0.2 M TBAPF6 electrolyte and 2.0 mM TCQ analyte concentrations. FIG. 5B shows normalized electronic absorption spectra of TCQ2− obtained during UV-vis SEC experiments. Experiments were performed in DMF containing no alcohol (black trace), 1M ethylene glycol (orange trace), 2M ethanol (blue trace), or 2M tert-butanol (red trace) with 0.2 M TBAPF6 electrolyte and 0.7 mM TCQ under CO2 atmosphere. In the presence of 1M ethylene glycol, some protonation (to form the corresponding hydroquinone TCQH2, green trace) is observed.

FIG. 6 shows a general reaction coordinate diagram of the two-electron reduction of a quinone and binding to CO₂ in the absence (black) or presence (blue) of a hydrogen-bonding donor.

FIG. 7 shows equilibrium constants for TCQ²⁻ and TCQ(CO₂)²⁻ in DMF and DMSO under CO₂ and N₂ atmosphere with various alcohol hydrogen-bond donors.

FIGS. 8A-8C show hydrogen-bonding Interactions by Alcohol pKₐ. Plots of Log(K_{HB}^{N2}) (FIG. 8A), Log(K_{HB}^{CO2}) (FIG. 8B), and ΔLog(K_{HB}⁽²⁻⁾) (FIG. 8C) versus alcohol pKₐ (H₂O) for DMF solutions of TCQ containing various alcohol additives. The dotted black line indicates where ΔLog(K_{HB}⁽²⁻⁾)=0.

FIG. 9 shows cyclic voltammograms of TCQ in DMF and 2M EtOH in DMF under 1 atm N₂ and CO₂. Cyclic voltammograms of TCQ under N₂ (black), 10% CO₂ (red), or 100% CO₂ (blue) atmosphere in pure DMF (top) or 2M EtOH: DMF (bottom). Voltammograms were recorded at 100 mV/sec scan rate with solutions containing 0.2 M TBAPF₆ electrolyte and 2.0 mM TCQ. The reversible couple centered at 0.0 V corresponds to [Fe(C₅H₅)₂]^{+/0}. Vertical dotted black lines indicate the potential of E(O₂/O₂^{⋅-})_{1/2} in each solvent mixture.

FIGS. 10A-10B show an electrochemical Cycle for CO₂ Capture and Release. FIG. 10A shows a schematic of the H-cell setup utilized for electrochemical CO₂ capture electrolyses, showing the TCQ-based processes occurring in each cell during the capture and release steps of the eCCC cycle. FIG. 10B shows a charge versus time plot (black trace) of electrochemical CO₂ capture and release from 89:8:3 N₂:CO₂:O₂ with [TBA]₂[TCQ²⁻] in 2M ethanol in DMF. Headspace CO₂ concentration was monitored periodically during the course of the experiment (blue squares).

### DETAILED DESCRIPTION OF THE INVENTION

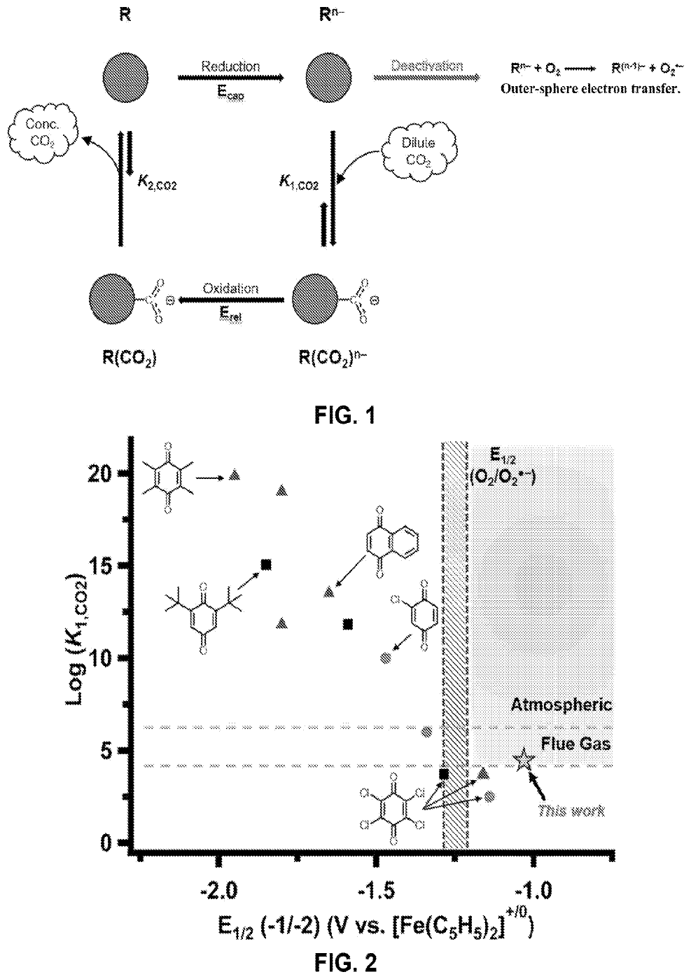

Referring now to FIGS. 1-10B, the present invention features a system for electrochemical carbon dioxide capture and concentration. In preferred embodiments, the system includes one or more redox capture agents, and one or more stabilizing agents configured to cause a positive shift of the reduction potential of the capture agent or agents such that the capture agent or agents may be reduced in the presence of oxygen without causing reduction of oxygen.

As a non-limiting example, the system for electrochemical carbon dioxide capture and concentration, may include a redox capture agent and a stabilizing agent. As used herein, the term “redox capture agent” refers to a chemical agent that can be reduced or oxidized to reversibly bind a molecule, element, or ion of interest. As such, the redox capture agent may have a reduced state and an oxidized state and a reduction potential from the oxidized state to the reduced state. As a non-limiting example, the capture agent may be applicable for the capture of CO₂.

As used herein, the term “stabilizing agent” refers to a chemical agent which causes a shift in either the reduction potential of the capture agent, the binding constant of the capture agent, or both. In some embodiments, the stabilizing agent may cause a positive shift of the reduction potential of the capture agent such that the capture agent may be reduced in the presence of oxygen without causing reduction of the oxygen. In some embodiments, the stabilizing agent may improve solubility of the capture agent. In an additional embodiment, a stabilizing functional group may be covalently linked with a capture agent such that the resulting molecule may function as both a capture agent and a stabilizing agent.

In some embodiments, the system may additionally include a solvent, such as a polar protic solvent. Non-limiting examples of solvents which may be used include methanol, ethanol, tert-butanol, isopropanol, water, and ethylene glycol. As a non-limiting example, a concentration of the stabilizing agent in the solvent may be about 2M. In other embodiments, a concentration of the stabilizing agent may range from about 0.001 M to neat solvent.

According to some preferred embodiments, the capture agent has a relatively high binding constant for CO₂ (or another molecule, element, or ion of interest) in the reduced state and a relatively low binding constant for CO₂ (or another molecule, element, or ion of interest) in the oxidized state. In some embodiments, the reduction potential of the capture agent may be shifted to be positive of the reduction potential of oxygen. The stabilizing agent may be configured to stabilize both the reduced state of the capture agent and its CO₂ adduct. In some embodiments, the stabilizing agent may be configured to stabilize the reduced state of the capture agent more than its CO₂ adduct. In other embodiments, the stabilizing agent is configured to stabilize the CO₂ adduct more than the reduced state of the capture agent.

In selected embodiments, the stabilizing agent may be a hydrogen-bond donor. As non-limiting examples, the stabilizing agent may include an alcohol functional group, a charged functionality (i.e. ammonium), or a cation (i.e. NH₄+, Li+, or Na+). Non-limiting examples of compounds which may be used as stabilizing agents include ethanol, methanol, hexanol, 2-methoxyethanol, ethylene glycol, tert-butanol, another alcohol, water, a primary amine, a secondary amine, and a cation. Other non-limiting examples of compounds which may be used as stabilizing agents include non-cationic Lewis acids. Non-limiting examples of non-cationic Lewis acids include boron derivatives. Further non-limiting examples of compounds which may be used as stabilizing agents include agents with any intramolecular or intermolecular interactions. As one non-limiting example, the stabilizing agent may have a pKₐ of about 14-18. As another non-limiting example, the stabilizing agent may have a pKₐ of about 16. As other non-limiting examples, the stabilizing agent may have a pKₐ of about 0-1, 1-2, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 20-21, 21-22, 22-23, 23-24, 24-25, 25-26, 26-27, 27-28, 28-29, 29-30, or greater than 30. In some embodiments, the pKₐ of the stabilizing agent is selected such that the stabilizing agent does not protonate the capture agent.

In some embodiments, the capture agent comprises quinone, or a functionalized quinone. In other embodiments, the capture agent may be a bipyridine or a thiol. The capture agent may be negatively charged in its reduced state. The capture agent may include any redox-active molecule that has differential binding to carbon dioxide in different oxidation states. The capture agent may include any compound that can capture and release carbon dioxide depending on external stimuli. External stimuli may include light and/or redox potential. As one non-limiting example, the log(K_{CO2}) of the stabilized capture agent may be greater than about 3.2. As another non-limiting example, the log(K_{CO2}) of the stabilized capture agent may be greater than about 5.5.

In some embodiments, the present invention features a method for electrochemical carbon dioxide capture and concentration. As a non-limiting example, the method may include: providing a capture solution comprising a redox capture agent and a stabilizing agent; reducing the capture agent to a reduced state; and exposing the reduced capture agent to CO₂ such that the reduced capture agent binds CO₂ to form a CO₂ adduct. In preferred embodiments, the stabilizing agent causes a positive shift of the reduction potential of the capture agent such that the capture agent may be reduced in the presence of oxygen without causing reduction of the oxygen. The method may also include oxidizing the CO₂ adduct to release the captured CO₂ . Corresponding methods may also be used for the reversible binding of compounds, elements and ions other than CO₂.

In some embodiments, the present invention features a method of tuning a system for electrochemical carbon dioxide capture and concentration. As a non-limiting example, the method may include: determining a desired reduction potential and a desired CO₂ binding constant for a redox capture agent; determining the pKa or Lewis acidity dependence of each of a plurality of additives on the reduction potential; determining the pKa or Lewis acidity dependence each of the plurality of additives on CO2 binding; and using the two relationships to identify an optimal pKa or Lewis acidity of an additive to achieve the desired reduction potential and CO₂ binding constant. The relationships may be determined either experimentally or computationally.

### EXAMPLE

The following is a non-limiting example of the present invention. It is to be understood that said example is not intended to limit the present invention in any way. Equivalents or substitutes are within the scope of the present invention.

Example 1: Commercial chemicals work together for efficient electricity-driven CO₂ capture and concentration from simulated flue gas.

O₂-stable electrochemical CO₂ capture and concentration (eCCC) using redox carriers from flue gas concentrations is reported in this example. Alcohol additives were used to stabilize the dianion and CO₂-bound forms of 2,3,5,6-tetrachloro-p-benzoquinone (TCQ) in dimethylformamide through intermolecular hydrogen-bonding interactions, preventing deleterious reactivity with O₂. The strength of these interactions was correlated to alcohol pKₐ to identify ethanol as the optimal additive. A full cycle of eCCC in aerobic simulated flue gas is completed using these commercially available compounds. Based on the system properties, an estimated minimum of 21 KJ/mol is required to concentrate CO₂ from 10% to 100%, or about half of what is required from state-of-the-art thermal amine capture systems and other reported redox carrier-based systems. Furthermore, this approach is general and can be used to optimize the redox properties of other quinones/alcohol combinations for specific CO₂ capture applications.

Avoiding the most severe climate effects from anthropogenic carbon dioxide (CO₂) emissions requires the advancement of CO₂ capture and concentration (CCC) technology. Currently, most approaches to CCC use thermal swings, which are energetically inefficient and expensive. There are several advantages for using electrochemical methods (eCCC) over thermal-swings. These include independence from Carnot limitations to achieve theoretical efficiencies of up to 100%, operation at ambient temperatures, modular scalability for point source applications, and the use of increasingly economical renewable electricity.

A common approach to eCCC is the use of redox carriers. Redox carriers have two stable oxidation states, shown as R and Rⁿ⁻ in FIG. 1. In the reduced state (Rⁿ⁻), the carrier has a high binding constant (K_{1,CO2}) to facilitate CO₂ capture from dilute streams. In the oxidized state (R), the carrier has a low binding constant (K_{2,CO2}) allowing for CO₂ release and concentration. Several classes of redox-active carriers have been investigated for eCCC applications including bipyridines, thiols, and quinones. However, eCCC systems generally degrade from aerobic input streams because the reduced carriers react with oxygen (O₂) resulting in unproductive carrier oxidation and the generation of superoxide, which can cause destructive radical reactions with the carrier, solvent, or electrolyte (red reaction in FIG. 1). Since oxygen is present in flue gas and atmospheric CO₂ sources, practical eCCC methods must overcome this limitation.

Aerobic stability is possible if E_{1/2}(R/Rⁿ⁻) (E_{cap} in FIG. 1) is positive of the O₂/O₂^{⋅-} reduction potential. The range of this reduction potential in a few different solvents is demarcated by the dashed black lines in FIG. 2. The second key parameter for a redox carrier is its CO₂ binding constant (K_{1,CO2}), which must also be optimized for the application. For example, in order to attain >90% capture efficiency (>90% of incoming CO₂ is captured by the solution in a single pass), log(K_{1,CO2}) must be greater than ˜3.2 and ˜5.5 for capture from flue gas and atmospheric concentrations, respectively. The minimum value of log(K_{1,CO2}) needed for flue gas or atmospheric capture is also shown as the dashed green and blue lines, respectively in FIG. 2. The shaded green and blue regions indicate the working regimes required for O₂ stable eCCC from flue gas or atmospheric resources.

Among reported redox carriers for eCCC, quinones have shown particular promise, with greater CO₂ binding constants at milder potentials compared to other organic redox carriers (FIG. 2). Under anaerobic conditions, quinones have performed eCCC from concentrations of less than 1% to greater than 90%. Quinones are also currently produced at large scales, economical, and easily modified through functionalization. Electronic structure modifications through functionalization of quinones results in a linear free energy relationship (LFER) between the binding constant (log(K_{1,CO2})) and reduction potential (E_{1/2}) (FIG. 2). As a result, all previously explored redox carriers fall outside of the required working regimes for aerobic flue gas and atmospheric capture applications (FIG. 2).

As the two key properties for a redox carrier cannot be independently tuned through conventional functionalization, we pursued the use of intermolecular hydrogen bonding interactions through alcohol additives to break the LFER. Our studies demonstrate that common alcohol additives result in beneficial changes to the two key properties of a redox carrier—reduction potential and CO₂ binding constant. We also describe how hydrogen-bonding interactions are optimizable through the pKa of the alcohol additive. Using this approach, we demonstrate efficient O₂-stable eCCC from flue gas concentrations using a commercially available quinone and alcohol.

The use of alcohol additives described herein provides a facile approach for tuning the redox carrier properties into desirable ranges that are not accessible through traditional molecular functionalization. This approach can be applied to optimize redox carrier properties for different eCCC applications using easily accessible quinone and alcohol combinations.

### Results

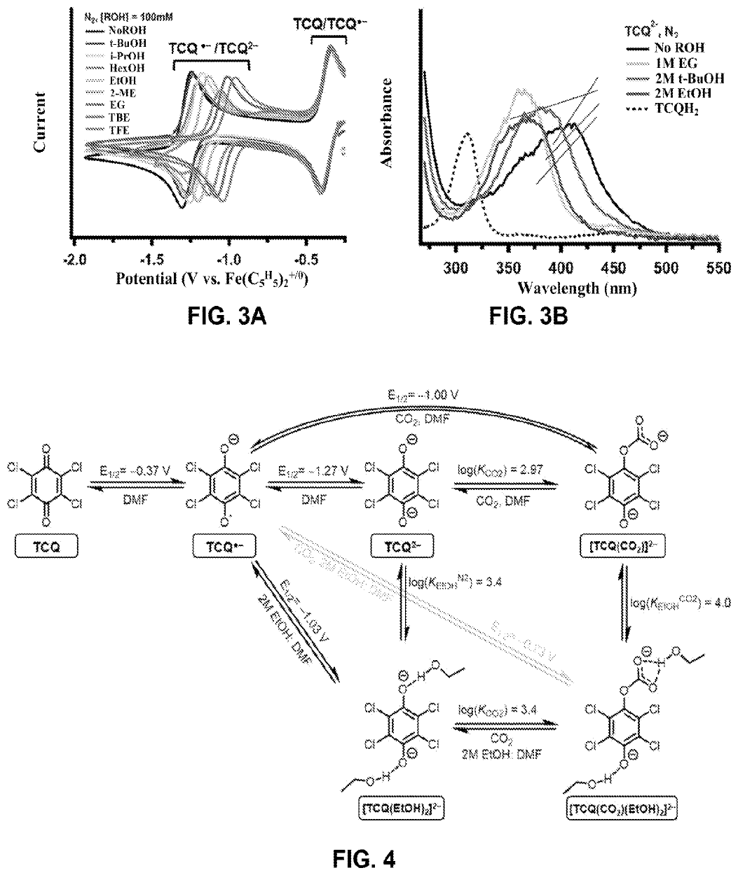

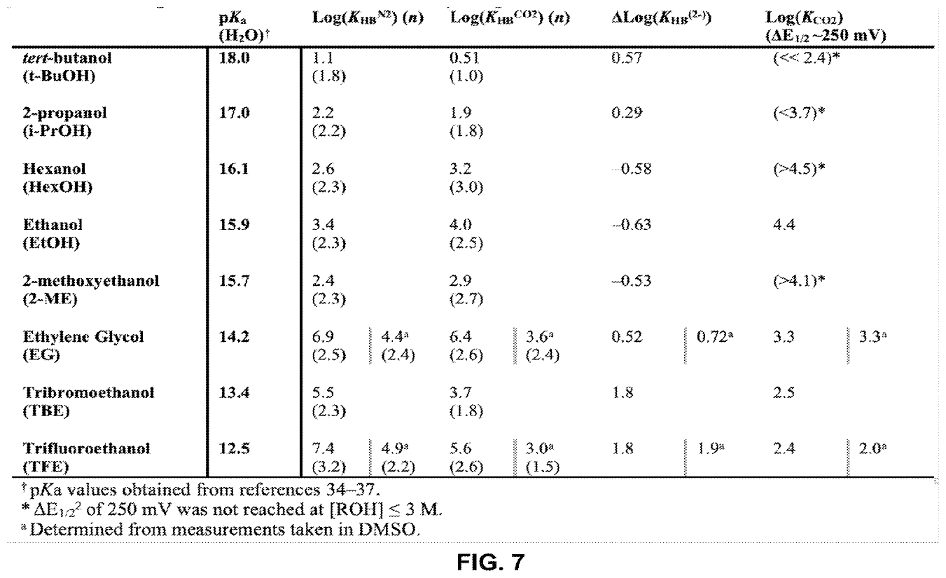

Reduction of TCQ Under an N₂ Atmosphere and Effect of Added Alcohols. Cyclic voltammetry (CV) of 2,3,5,6-tetrachloro-p-benzoquinone (TCQ) in the absence of hydrogen-bonding interaction under an N₂ atmosphere exhibits two reversible, one-electron reductions in polar aprotic solvents, such as dimethylformamide (DMF, black trace FIG. 3A), dimethylsulfoxide, (DMSO), acetonitrile (CH₃CN), and benzonitrile (PhCN). Similar to the studies reported by Linschitz and Gupta, the addition of weakly acidic alcohols (pKₐ(H₂O)≥12.5) to solutions of TCQ in DMF or DMSO under an N₂ atmosphere shifts the second reduction event (E(TCQ^{⋅-}/TCQ²⁻)_{1/2}) to more positive potentials, while the first reduction event (TCQ/TCQ^{⋅-}) remains unaffected (FIG. 3A). Eight alcohol additives (2, 2, 2-trifluoroethanol (TFE), 2, 2, 2-tribromoethanol (TBE), ethylene glycol (EG), 2-methoxyethanol (2-ME), ethanol (EtOH), hexanol (HexOH), 2-propanol (i-PrOH), and tert-butanol (t-BuOH)) were used in this study and all resulted in anodic shifts in potential, with some in excess of 350 mV (FIG. 3A). For all alcohols, the magnitude of the anodic shift increases with alcohol concentration; however, at each concentration the shift is larger for alcohols with lower pKₐ values (pKₐ values are shown in FIG. 7). Both reduction events remain reversible with alcohol additives at all scan rates measured (v=10-1000 mV/sec). Cyclic voltammograms of chemically prepared [TBA]₂[TCQ²⁻] in DMF with 2M ethanol are nearly identical to that of TCQ in the same solvent mixture, with no evidence of decomposition after several hours.

Hydrogen-bonding interactions with EG, t-BuOH, and EtOH and the reduced TCQ species were further investigated using UV-visible spectroscopy and spectroelectrochemistry (UV-vis SEC). UV-vis SEC of TCQ in the absence of hydrogen-bond donors in DMF indicates that the quinone (TCQ), radical anion (TCQ^{⋅-}), dianion (TCQ²⁻), and doubly-protonated dianion (TCQH₂) have distinct absorbance features. The addition of alcohols results in a blue-shift (decrease in wavelength) in the absorbance of TCQ²⁻ (FIG. 3B), while the absorbance spectra of TCQ, TCQ^{⋅-}, and TCQH₂ are unaffected. Further, this change in λₘₐₓ for TCQ²⁻ is larger for alcohols with lower pKₐ (FIG. 3B). However, while the shift in the absorption spectra of TCQ²⁻ indicates that the alcohols interact with the dianion, they do not correspond to TCQH₂, signifying TCQ²⁻ is not being protonated. UV-visible spectra of chemically synthesized [TBA]₂[TCQ²⁻] has the same features and do not change over several hours. The spectroscopic, electrochemical, and spectroelectrochemical data all indicate that the introduction of alcohols stabilizes TCQ²⁻, resulting in anodic shifts to the E(TCQ^{⋅-}/TCQ²⁻)_{1/2} potential—in some cases positive of the O₂/O₂^{⋅-} reduction potential in DMF—without resulting in protonation or decomposition.

### CO₂ Binding to TCQ Dianion and Effect of Alcohol Additives.

Under an N₂ or CO₂ atmosphere, no changes occur in the UV-vis SEC absorption spectra of TCQ and singly reduced TCQ^{⋅-}, confirming that neither species reacts with CO₂. In contrast the absorption spectra of TCQ²⁻ is significantly blue-shifted in the presence of CO₂ , indicating CO₂ binding. Similar to other quinones, TCQ²⁻ reacts with CO₂ to form an aryl carbonate species (FIG. 4), which we have characterized by ¹³C NMR and Fourier-transform infrared (FTIR) spectroscopy.

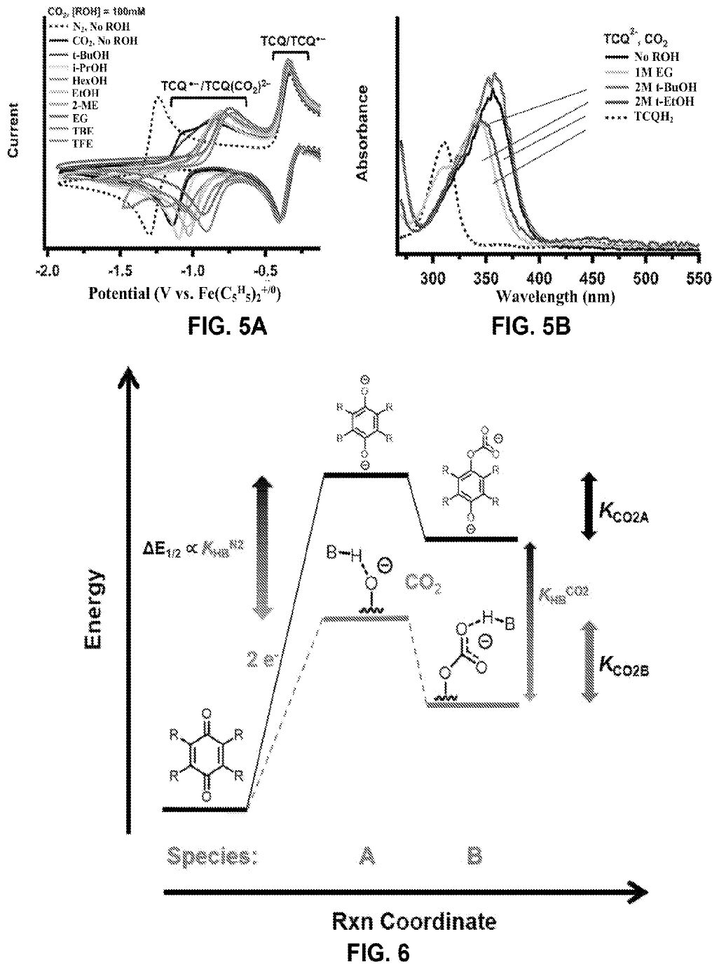

UV-vis SEC studies with added ethylene glycol, tert-butanol, and ethanol also result in no changes to the electronic absorption spectra between an N₂ and CO₂ atmosphere for TCQ and TCQ^{⋅-}. However, the absorption corresponding to [TCQ(CO₂)]²⁻ is further blue-shifted in the presence of alcohol additives (FIG. 5B). Of the three alcohols, only ethylene glycol appears to protonate TCQ²⁻ to form TCQH₂, which was not observed under an N₂ atmosphere. The electronic absorption spectrum of chemically synthesized [TBA]₂[TCQ²⁻] in 2M ethanol in DMF under CO₂ is nearly identical to TCQ²⁻ generated electrochemically under the same conditions.

CO₂ binding at TCQ²⁻ is also evident by comparing the cyclic voltammograms of TCQ recorded under N₂ and CO₂ atmospheres. While the first reduction to TCQ^{⋅-} is identical under both conditions, the second reduction features an anodic shift in E_{1/2} in the presence of CO₂ , indicating an EᵣEᵣCᵣ event, or two reversible electron transfer events followed by a rapid reversible chemical step (CO₂ binding, FIG. 5A). The addition of alcohol additives under CO₂ results in a further anodic shift in the second reduction event, E (TCQ^{⋅-}/TCQ²⁻)_{1/2} (FIG. 5A). The magnitude of the anodic shift correlates with increasing concentration and decreasing pKₐ of the alcohol (FIGS. 5A-5B). These results indicate that the CO₂ adduct of TCQ²⁻ ([TCQ(CO₂)]²⁻) is also stabilized by hydrogen-bonding interactions. Chemically synthesized [TBA]₂[TCQ²⁻] in the presence of ethanol under a CO₂ atmosphere feature CVs that are almost identical to solutions of TCQ under the same conditions, even after sitting in solution for several hours. CVs and electronic absorption spectra of a [TBA]₂[TCQ(CO₂)²⁻] solution after addition of ethanol are indistinguishable from those when CO₂ is added to an ethanol-containing solution of [TBA]₂[TCQ²⁻], which verifies that the same product is formed and establishes that CO₂ can insert into the hydrogen-bonds formed between ethanol and TCQ²⁻ in solution.

Once formed, TCQ(CO₂)²⁻ can be oxidized, resulting in the loss of bound CO_{2.} UV-vis SEC with solutions of [TBA]₂[TCQ²⁻] in pure DMF or 2M EtOH in DMF show quantitative conversion into TCQ^{⋅-} or TCQ upon one or two-electron oxidation under both N₂ and CO₂ atmospheres. These features are also present in the CVs of chemically synthesized [TBA]₂[TCQ²⁻] recorded in the presence or absence of EtOH under N₂ or CO₂ atmosphere, when the species is TCQ(CO₂)²⁻.

The anodic shift of E(TCQ^{⋅-}/TCQ²⁻)_{1/2} under CO₂ versus N₂ atmosphere can be used to calculate the CO₂ binding constant (K_{1,CO2}) of TCQ²⁻ using equation 1.

$${E}_{1 / 2} = {E}^{{0}^{′}} + \frac{R T}{n F} ln ln ( {K}_{{CO}_{2}} ) + q \frac{R T}{n F} ln [ {CO}_{2} ] \qquad 1$$

In equation 1, R is the gas constant, T is temperature, F is Faraday's constant, and n is the number of electrons being passed in the redox event (n=1 for E(TCQ^{⋅-}/TCQ²⁻)_{1/2}). The number of CO₂ molecules that are bound is represented by the term q (which was previously determined to be one for TCQ). E^{o ′} and E_{1/2} are the half-wave potential in the absence of CO₂ and in the presence of a known CO₂ concentration in solution ([CO₂]), respectively. Using this method, the log(K_{CO2}) of TCQ²⁻ is 3.7±0.2 in the absence of hydrogen-bond donors in DMF.

Comparison of the E(TCQ^{⋅-}/TCQ²⁻)_{1/2} under N₂ and CO₂ atmospheres with alcohol additives were used to measure K_{CO2} according to equation 1. K_{CO2} steadily decreases (decreasing ΔE) with increasing concentrations of 5 of the 8 alcohols investigated (trifluoroethanol, tribromoethanol, ethylene glycol, 2-propanol, or tert-butanol) in both DMF and DMSO. Thus, even though these alcohols shift E^{o ′} (TCQ^{⋅-}/TCQ²⁻) into the desired aerobic operating regime (green region, FIG. 2), K_{1,CO2} also decreases. As a result, these alcohols do not perform better than other functionalized quinones without hydrogen-bonding (FIG. 2) for flue gas capture applications. However, three of the alcohols (ethanol, hexanol, and 2-methoxyethanol) exhibit the opposite behavior, with increased values of K_{CO2} at higher alcohol concentration. The increased CO₂ binding affinities at milder potentials afforded by these additives shifts TCQ into the desired operating regime for flue gas capture (black square vs. orange star, FIG. 2), successfully breaking the LFER to make them viable candidates for eCCC from flue gas concentrations containing O₂.

Spectrophotometric experiments were used to independently verify the electrochemically-derived K_{CO2} values. Titration of [TBA]₂[TCQ²⁻] with CO₂ was monitored using electronic absorption spectroscopy. [TBA]₂[TCQ²⁻] quantitatively converts into TCQ(CO₂)²⁻ upon addition of 1 equivalent of CO₂ in pure DMF and 2M ethanol in DMF solutions. For each of the titrations, K_{CO2} was calculated from the disappearance of the absorption corresponding to TCQ²⁻ using the Benesi-Hildebrand method. From this data, TCQ²⁻ has values of log(K_{CO2})=2.97±0.04 and 3.4±0.2 in pure DMF and 2M ethanol in DMF, respectively. While these values are slightly lower than those measured using voltametric methods (log(K_{CO2})=3.7±0.2 and 4.3±0.2 for DMF and 2M ethanol in DMF, respectively) they confirm the trend found using electrochemical methods. Importantly, the CO₂ binding constant measured by both methods in the presence of ethanol is sufficient for capture from flue gas concentrations.

Optimizing the Hydrogen-Bonding Interactions with Reduced TCQ Species

In order to advance the development of air-stable eCCC carriers, it is important to understand why addition of ethanol, hexanol, and 2-methoxyethanol break the LFER for TCQ, while the other alcohols (trifluoroethanol, tribromoethanol, ethylene glycol, 2-propanol, and tert-butanol) do not. FIG. 6 shows a general reaction coordinate diagram for quinone reduction and binding to one molecule of carbon dioxide based on an EEC mechanism. Species A is the doubly reduced quinone dianion and species B is its CO₂ adduct. The interaction of a hydrogen-bond donor can stabilize both species A and B. The magnitude in which the two key redox carrier properties (E_{1/2} and K_{1,CO2}) change relies on the relative stabilization of A and B. If species A and B are stabilized to the same degree, there should be little to no effect on K_{CO2}, as it is directly dictated by the energy difference between the two species, however the reduction potential will be anodically shifted. As a result, proper tuning of intermolecular hydrogen-bonding interactions with both species A and B is required to break the LFER shown in FIG. 2 and permit stability under aerobic conditions.

We hypothesized that the drop in K_{CO2} with increasing alcohol concentration for trifluoroethanol, tribromoethanol, ethylene glycol, 2-propanol, and tert-butanol was due to disproportionate stabilization of TCQ²⁻ versus [TCQ(CO₂)]²⁻ (species A vs B in FIG. 6). To evaluate this hypothesis, the strength of the hydrogen-bonding interactions between TCQ²⁻ and [TCQ(CO₂)]²⁻ with each alcohol were quantified using cyclic voltammetry. The reduction of TCQ^{⋅-} to TCQ²⁻, and consequent hydrogen-bond formation with n number of hydrogen-bond donors (HB), can be represented by the following chemical steps:

TCQ^{⋅-}+e⁻ [symbol] TCQ²⁻

TCQ²⁻+n HB [symbol] TCQ²⁻(HB)ₙ

From this series of equilibria and the Nernst equation, the equilibrium constant of the dianion with n molecules of hydrogen-bond donor, HB (K_{HB}⁽²⁻⁾), can be calculated using equation 2.

$$exp ( f Δ {E ( {TCQ}^{- 1} / {TCQ}^{- 2} )}_{1 / 2} ) = 1 + {{K}_{HB}^{( 2 - )} [ HB ]}^{n} \qquad 2$$

The difference between K_{HB}^{CO2} and K_{HB}^{N2}, represented as ΔLog(K_{HB}⁽²⁻⁾) (where ΔLog(K_{HB}⁽²⁻⁾)=K_{HB}^{N2}−K_{HB}^{CO2}), effectively measures how much more (or less) TCQ²⁻ is stabilized by hydrogen-bonding interactions compared to [TCQ(CO₂)]²⁻ (displayed graphically in the reaction coordinate diagram shown in FIG. 6). If a hydrogen-bond donor stabilizes [TCQ(CO₂)]²⁻ more than TCQ²⁻ (ΔK_{HB}⁽²⁻⁾<0), CO₂ binding will be more favorable and K_{CO2} will increase as the concentration of hydrogen-bond donor in solution increases. Conversely, if TCQ²⁻ is more stabilized (ΔLog(K_{HB}⁽²⁻⁾)>0), then CO₂ binding will be less favored, and K_{CO2} will decrease.

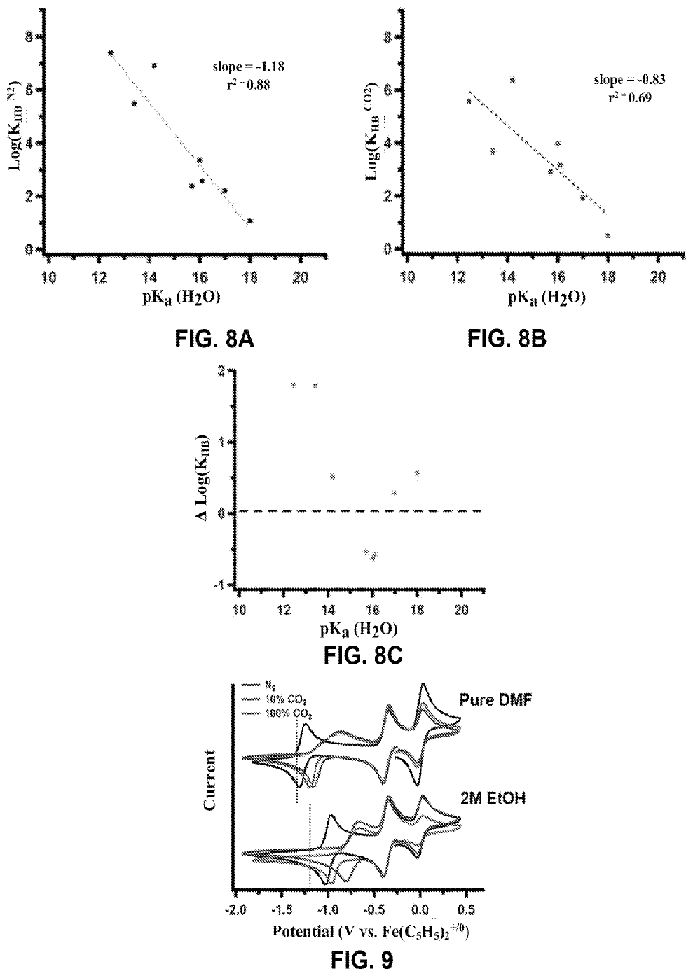

FIG. 7 lists values for K_{HB}⁽²⁻⁾ and n under N₂ (K_{HB}^{N2}) or CO₂ (K_{HB}^{CO2}) atmosphere, as well as ΔLog(K_{HB}⁽²⁻⁾) for each of the alcohols investigated. As shown in FIG. 8A, there is a linear correlation between log(K_{HB}^{N2}) and the pKₐ of the alcohol additive, where more acidic alcohols have larger values of K_{HB}^{N2}. Likewise, a plot of log(K_{HB}^{CO2}) versus pKₐ shows a similar linear relationship, albeit with a shallower slope (FIG. 8B). The relationship between ΔLog(K_{HB}⁽²⁻⁾) and pkₐ is not linear, but is in fact v-shaped (FIG. 8C). ΔLog(K_{HB}⁽²⁻⁾) decreases with increasing pKₐ up until a certain point (pKₐ˜16), after which ΔLog(K_{HB}⁽²⁻⁾) starts increasing. Three of the alcohols investigated (ethanol, hexanol, and 2-methoxyethanol) have ΔLog(K_{HB}⁽²⁻⁾) values less than zero. This result is consistent with changes in K_{CO2} with increasing concentration of each of the alcohols investigated. Verifying our hypothesis, the correlation between ΔLog(K_{HB}⁽²⁻⁾) and K_{CO2} indicates that the hydrogen-bonding interactions of each alcohol with [TCQ(CO₂)]²⁻ and TCQ²⁻ needs to be finely tuned to promote CO₂ binding at milder potentials. Thus, the alcohols with ΔLog(K_{HB}⁽²⁻⁾)<0 have pKₐ's around 16, while alcohols with either higher or lower pKₐ have ΔLog(K_{HB}⁽²⁻⁾)>0, although it is possible that the higher values of ΔLog(K_{HB}⁽²⁻⁾) for 2-propanol and tert-butanol are not a result of pKₐ, but increased steric hindrance.

In addition to alcohol pKₐ, solvent identity also affects K_{HB}^{N2} and K_{HB}^{CO2}. Measured values of K_{HB}⁽²⁻⁾ in DMSO are several orders of magnitude lower than those obtained in DMF (TFE and ethylene glycol, FIG. 7). Lower values of K_{HB}⁽²⁻⁾ in DMSO likely arise from its larger solvent donor number compared to DMF. This would result in stronger hydrogen-bonds formed between the alcohol and solvent molecules that are more difficult to disrupt to form hydrogen-bonding interactions with TCQ²⁻ or [TCQ(CO₂)]²⁻. This hypothesis is further supported by prior studies, which report K_{HB}^{N2} values for TCQ²⁻ with ethanol and TFE that are significantly larger in acetonitrile and benzonitrile (which have lower donating abilities than DMF or DMSO) than what we measured in DMF and DMSO.

From the alcohols studied, ethanol is the most promising candidate for use in an eCCC system utilizing TCQ as the redox carrier, due to its favorable values of K_{HB}^{CO2}, K_{HB}^{N2}, and ΔLog(K_{HB}⁽²⁻⁾). Ethanol's large K_{HB}^{N2} means that that E(TCQ^{⋅-}/TCQ²⁻)_{1/2} is shifted significantly positive without a large concentration of alcohol. For example, at 2M ethanol concentration, E(TCQ^{⋅-}/TCQ²⁻)_{1/2} is shifted over 230 mV positive than in the absence of an alcohol (black traces, FIG. 9). Importantly, this potential is 200 mV positive of E(O₂/O₂^{⋅-})_{1/2} (potential at half-maximum current=−1.30 V vs. [Fe(C₅H₅)₂]^{+/0} at a glassy carbon electrode in pure DMF, or −1.20 V vs. [Fe(C₅H₅)₂]^{+/0} in DMF containing 2M ethanol, FIG. 9), thereby avoiding undesirable losses in faradaic efficiency from O₂ reduction or carrier decomposition from superoxide generation. Additionally, K_{HB}^{CO2} is larger than K_{HB}^{N2} for ethanol, resulting in a negative ΔLog(K_{HB}⁽²⁻⁾) which indicates that CO₂ binding is not weakened by hydrogen-bonding interactions, but is in fact strengthened by them. Altogether, these properties indicate that when combined with a hydrogen-bond donor such as ethanol, TCQ becomes an effective redox carrier for eCCC from aerobic streams at flue gas concentrations.

### Bulk CO₂ Capture and Release Studies

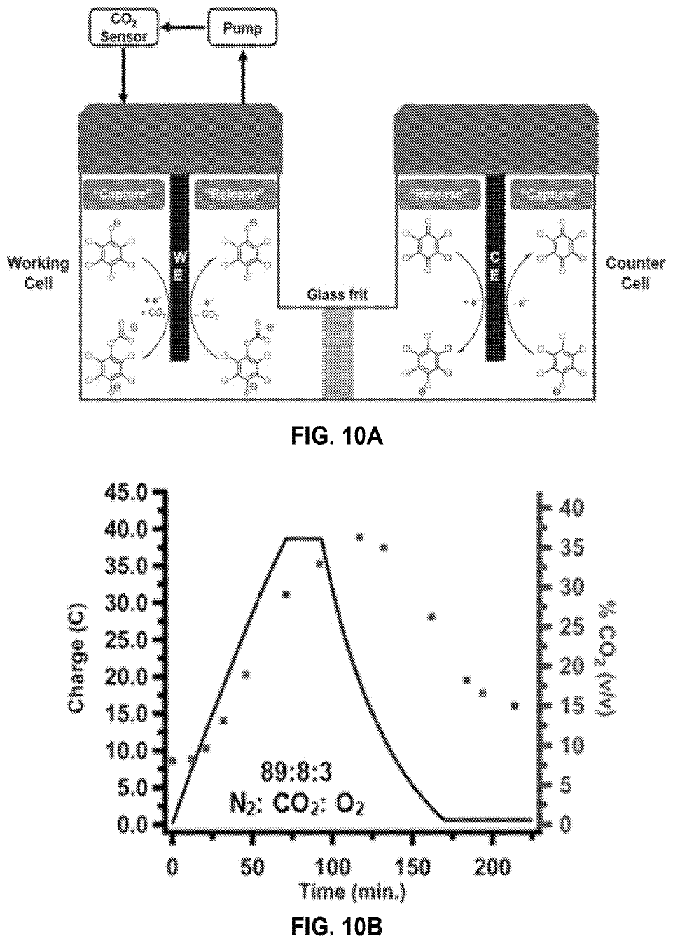

The combined redox and CO₂ binding properties of TCQ²⁻ with ethanol additives prompted us to investigate whether this system could be used to capture and release CO₂ from flue gas concentrations in the presence of O₂. A closed system was used to complete CO₂ capture and release from 10% CO₂ sources. The electrolysis was performed using a sealed H-cell similar to the one depicted in FIG. 10A, where the CO₂ concentration of the working cell headspace was periodically monitored through an IR CO₂ analyzer in a closed loop using a small pump that circulated the headspace. Each cycle was initiated by sparging a solution of chemically synthesized [TBA]₂[TCQ²⁻] in the working compartment with simulated flue gas to form TCQ(CO₂)²⁻. An oxidizing potential was then applied to the working cell solution to release bound CO₂ and form TCQ^{⋅-}. TCQ was used as a sacrificial oxidant in the counter cell to balance charge and limit undesirable crossover effects. Once oxidation was complete, the working cell solution was then reduced to reform TCQ²⁻ and capture the CO₂ released in the previous step.

In the absence of ethanol, CO₂ capture and release was tested with TCQ using simulated aerobic (87:10:3, N₂:CO₂:O₂ (v/v)) and anaerobic (90:10, N₂: CO₂ (v/v)) flue gas mixtures. Experimental details and results are described in the SI. Although capture and concentration are observed in both cases, decomposition occurs upon reduction of the carrier, which prevents re-capture of the CO₂ released.

When the same capture cycle experiment is performed in the presence of 2M ethanol, the system completes the entire electrochemical capture cycle. Under a 89:8:3, N₂:CO₂:O₂ (v/v) atmosphere, a 50 mM solution of [TBA]₂[TCQ²⁻] in 2M ethanol in DMF captured and concentrate CO₂ from 8.0% to 36.3% (v/v), passing 38.4 Coulombs of charge during the oxidation (FIG. 10B). The initial and final headspace CO₂ concentration and charge passed corresponds to a 95% Faradaic efficiency (FE) and 98% yield of released CO₂ based on the moles of TCQ²⁻ in solution. The solution was then reduced once more until a total charge of −37.8 Coulombs was passed. The CO₂ concentration in the headspace decreased from 36.3% to 15% (v/v), resulting in a 73% FE for the re-capture step.

The use of ethanol as an additive to TCQ-based eCCC systems provides enhanced O₂ stability, which is essential for practical eCCC. The batch-capture experiments performed with a closed H-cell system is similar to a 3-stage capture system, where the redox carrier is reduced or “activated” in the presence of CO₂ before being pumped over to the anodic cell where it is oxidized to release bound CO₂. The minimum thermodynamic requirement for this type of redox-carrier eCCC system can be estimated from the ΔE between the half-wave potentials of the carrier in the presence of its dilute CO₂ inlet stream (in this case, flue gas at 10% CO₂ v/v) and of its concentrated outlet stream (100% CO₂). Cyclic voltammograms of TCQ in the presence and absence of 2M ethanol under 10 and 100% CO₂ are shown in FIG. 9. In the absence of ethanol, ΔE of the half-wave potentials (conservatively measured as 30 mV from the potential at peak current) under 10% CO₂ and 100% CO₂ (the conditions under capture and release during reduction and oxidation, respectively) is 250 mV. This ΔE value corresponds to a minimum calculated work of 23.3 KJ/mol CO₂ captured, or 24% energetic efficiency (based on a minimum theoretical requirement of 5.6 KJ/mol for a 10-100% CO₂ concentration swing). At 2M ethanol concentration, ΔE drops to 220 mV between 10 to 100% CO₂, lowering the calculated work required to just 21.5 KJ/mol, which raises the calculated maximum energetic efficiency to 26%, which is almost twice as efficient as any other reported eCCC method, or state-of-the-art alkanolamine-based systems. We note that these calculations derive a minimum energetic requirement from the redox carrier properties. In a full electrolytic system, other factors would contribute to the operating efficiency including cell overpotentials, carrier solubility, and CO₂ solubility, which could all be optimized through cell engineering. Additionally, the CO₂ binding constant of the redox carrier can be further optimized for specific CO₂ concentrations to achieve even higher efficiencies.

### Conclusion

Electrochemical carbon dioxide capture and concentration (eCCC) is a modular approach that can achieve significantly higher energy efficiencies than current thermal methods. However, eCCC systems have been plagued by oxygen instability. This study describes the use of alcohol additives to stabilize a quinone through intermolecular hydrogen-bonding interactions. Optimizing these interactions through alcohol pKₐ and concentration results in beneficial changes to the redox properties and CO₂ binding, the two key parameters of an eCCC redox carrier. With TCQ, the optimal interactions were achieved in 2M ethanol in DMF, with a maximum theoretical efficiency of 26% for concentrating a 10% CO₂ stream to 100%. With this combination of commercially available compounds, this example demonstrates successful completion of a full cycle of electrochemical CO₂ capture and release in the presence of O₂ from flue gas concentrations, making a significant advance towards practical eCCC. Because the ideal redox carrier parameters will ultimately depend on the concentration of CO₂ in the targeted capture stream, this approach may be further used to generate a library of commercially available quinones and alcohol combinations optimized for application-specific, cost-effective, and scalable eCCC solutions.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

1. A system for electrochemical capture and concentration of a carbon compound, the system comprising:
a. a redox capture agent, having a reduced state and an oxidized state and a reduction potential from the oxidized state to the reduced state; and
b. a stabilizing agent;
wherein the stabilizing agent causes a positive shift of the reduction potential of the capture agent such that the capture agent may be reduced in the presence of oxygen without causing reduction of the oxygen.

2. The system of claim 1, additionally comprising a polar protic solvent.

3. The system of claim 2, wherein a concentration of the stabilizing agent in the solvent is about 2M.

4. The system of claim 1, wherein the carbon compound is carbon dioxide.

5. The system of claim 1, wherein the capture agent bas a relatively high binding constant for CO₂ in the reduced state and a relatively low binding constant for CO₂ in the oxidized state.

6. The system of claim 1, wherein the reduction potential of the capture agent is shifted to be positive of the reduction potential of oxygen.

7. The system of claim 1, wherein the stabilizing agent is configured to stabilize both the reduced state of the capture agent and a CO₂ adduct derived from the capture agent.

8. The system of claim 7, wherein the stabilizing agent is configured to stabilize the reduced state of the capture agent more than the CO₂ adduct.

9. The system of claim 7, wherein the stabilizing agent is configured to stabilize the CO₂ adduct more than the reduced state of the capture agent.

10. The system of claim 1, wherein the stabilizing agent comprises a hydrogen-bond donor.

11. The system of claim 1, wherein the stabilizing agent comprises ethanol, methanol, hexanol, 2-methoxyethanol, ethylene glycol, tert-butanol, another alcohol, water, a primary amine, a secondary amine, or a cation.

12. The system of claim 1, wherein the stabilizing agent has a pKₐ of about 14-18.

13. The system of claim 1, wherein the stabilizing agent does not protonate the capture agent.

14. The system of claim 1, wherein the capture agent comprises quinone, or a functionalized quinone.

15. The system of claim 1, wherein the capture agent is negatively charged in its reduced state.

16. The system of claim 1, wherein the log(K_{CO2}) of the stabilized capture agent is greater than about 3.2.

17. (canceled)

18. A method for electrochemical carbon dioxide capture and concentration, the method comprising:
a. providing a capture solution comprising a redox capture agent and a stabilizing agent;
b. reducing the capture agent to a reduced state;
c. exposing the reduced capture agent to CO₂ such that the reduced capture agent binds the CO₂ to form a CO₂ adduct;
wherein the stabilizing agent causes a positive shift of a reduction potential of the capture agent such that the capture agent may be reduced in a presence of oxygen without causing reduction of the oxygen.

19. The method of claim 18, additionally comprising oxidizing the CO₂ adduct to release the CO₂ captured by the capture agent.

20. A method of tuning a system for electrochemical carbon dioxide capture and concentration, the method comprising:
a. determining a desired reduction potential and a desired CO₂ binding constant for a redox capture agent;
b. determining a pKa or a Lewis acidity dependence of each of a plurality of additives on the reduction potential;
c. determining the pKa or the Lewis acidity dependence of each of the plurality of additives on CO₂ binding; and
d. identifying an optimal pKa or Lewis acidity of an additive of the plurality of additives based on the pKa or the Lewis acidity dependence of said additive on the reduction potential and the pKa or the Lewis acidity dependence of said additive on the CO₂ binding to achieve the desired reduction potential and the desired CO₂ binding constant.

21. The method of claim 20, wherein the pKa or the Lewis acidity dependence of the additive on the reduction potential and the pKa or the Lewis acidity dependence of the additive on the CO₂ binding are determined experimentally or computationally.
